(19) United States
(12) Patent Application Publication
(10) Pub. No.: US 2019/0354810 A1
(43) Pub. Date: Nov. 21, 2019

(54) ACTIVE LEARNING TO REDUCE NOISE IN LABELS

(71) Applicant: ASTOUND AI, INC., Menlo Park, CA (US)

(72) Inventors: Karan SAMEL, Pleasanton, CA (US); Xu MIAO, Los Altos, CA (US); Zhenjie Zhang, Fremont, CA (US); Masayo IIDA, Mountain View, CA (US); Maran NAGENDRAPRASAD, San Ramon, CA (US)

(21) Appl. No.: 16/418,848

(22) Filed: May 21, 2019

Related U.S. Application Data
(60) Provisional application No. 62/674,539, filed on May 21, 2018.

(51) Int. Cl. G06K 9/62; G06N 3/04; G06F 3/0482

(52) U.S. Cl. CPC G06K 9/6257; G06N 3/04; G06F 3/0482; G06K 9/6231; G06K 9/6219; G06K 9/6263

(57) ABSTRACT

One embodiment of the present invention sets forth a technique for processing training data for a machine learning model. The technique includes training the machine learning model using training data comprising a set of features and a set of original labels associated with the set of features. The technique also includes generating multiple groupings of the training data based on internal representations of the training data in the machine learning model. The technique further includes replacing, in a first subset of groupings of the training data, a first subset of the original labels with updated labels based at least on occurrences of values for the original labels in the first subset of groupings.

### CROSS-REFERENCE TO RELATED APPLICATIONS

This application claims priority benefit of the United States Provisional Patent Application titled, “Active Deep Learning to Reduce Noise in Labels,” filed on May 21, 2018, and having Ser. No. 62/674,539. The subject matter of this related application is hereby incorporated herein by reference.

### BACKGROUND

### Field of the Various Embodiments

Embodiments of the present invention relate generally to machine learning, and more particularly, to active learning to reduce noise in labels.

### Description of the Related Art

Machine learning may be used to discover trends, patterns, relationships, and/or other attributes related to large sets of complex, interconnected, and/or multidimensional data. To glean insights from large data sets, regression models, artificial neural networks, support vector machines, decision trees, naive Bayes classifiers, and/or other types of machine learning models may be trained using input-output pairs in the data. In turn, the discovered information may be used to guide decisions and/or perform actions related to the data. For example, the output of a machine learning model may be used to guide marketing decisions, assess risk, detect fraud, predict behavior, and/or customize or optimize use of an application or website.

In many machine learning applications, large training datasets must be inputted into a machine learning model to train the model to accurately identify one or more characteristics of the inputted data. For example, a machine learning model that performs image recognition may be trained with thousands or millions of input images, each of which must be manually labeled with a desired output that describes a relevant characteristic of the image.

In some applications, the correct label that should be assigned to each training sample may be relatively objective. For example, in the case of image recognition, a human may be able to accurately label a series of images as containing either a ‘cat’ or a ‘dog.’ However, in many applications, the process of manually labeling input data is more subjective and/or error prone, which may lead to incorrectly labeled training datasets. Such incorrectly labeled training data can result in a poorly trained machine learning model.

Further, due to the size of such training datasets, if even a relatively small percentage of the training data is incorrectly labeled, attempting to locate and correct the incorrect labels may be prohibitively time-consuming. Consequently, in many machine learning applications, training datasets may never be corrected, resulting in a suboptimal machine learning model being implemented to classify unseen input data.

As the foregoing illustrates, what is needed is a more effective technique for identifying and correcting noisy, dirty, inconsistent, and/or missing labels in training data for machine learning models.

### SUMMARY

One embodiment of the present invention sets forth a technique for processing training data for a machine learning model. The technique includes training the machine learning model using training data comprising a set of features and a set of original labels associated with the set of features. The technique also includes generating multiple groupings of the training data based on internal representations of the training data in the machine learning model. The technique further includes replacing, in a first subset of groupings of the training data, a first subset of the original labels with updated labels based at least on occurrences of values for the original labels in the first subset of groupings.

At least one advantage and technological improvement of the disclosed techniques is a reduction in noise, inconsistency, and/or inaccuracy in labels used to train machine learning models, which provide additional improvements in the training and performance of the machine learning models. Consequently, the disclosed techniques provide technological improvements in the training, execution, and performance of machine learning models and/or the execution and performance of applications, tools, and/or computer systems for performing cleaning and/or denoising of data.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computing device configured to implement one or more aspects of the present disclosure.

FIG. 2 is a more detailed illustration of the active learning framework of FIG. 1, according to various embodiments.

FIG. 3A is an example screenshot of a user interface provided by the verification engine of FIG. 2, according to various embodiments.

FIG. 3B is an example illustration of groupings of training data generated by the denoising engine of FIG. 2, according to various embodiments.

FIG. 4 is a flow diagram of method steps for processing training data for a machine learning model, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### System Overview

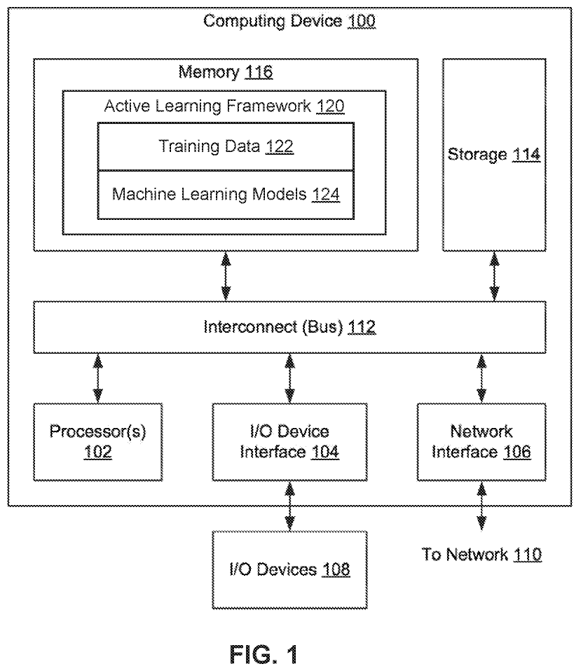

FIG. 1 illustrates a computing device 100 configured to implement one or more aspects of the present invention. Computing device 100 may be a desktop computer, a laptop computer, a smart phone, a personal digital assistant (PDA), tablet computer, or any other type of computing device configured to receive input, process data, and optionally display images, and is suitable for practicing one or more embodiments of the present invention. Computing device 100 is configured to run an active learning framework 120 for managing machine learning that resides in a memory 116. It is noted that the computing device described herein is illustrative and that any other technically feasible configurations fall within the scope of the present invention.

As shown, computing device 100 includes, without limitation, an interconnect (bus) 112 that connects one or more processing units 102, an input/output (I/O) device interface 104 coupled to one or more input/output (I/O) devices 108, memory 116, a storage 114, and a network interface 106. Processing unit(s) 102 may be any suitable processor implemented as a central processing unit (CPU), a graphics processing unit (GPU), an application-specific integrated circuit (ASIC), a field programmable gate array (FPGA), an artificial intelligence (Al) accelerator, any other type of processing unit, or a combination of different processing units, such as a CPU configured to operate in conjunction with a GPU. In general, processing unit(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 may include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 may be any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 may include non-volatile storage for applications and data, and may include fixed or removable disk drives, flash memory devices, and CD-ROM, DVD-ROM, Blu-Ray, HD-DVD, or other magnetic, optical, or solid state storage devices. Active learning framework 120 may be stored in storage 114 and loaded into memory 116 when executed. Additionally, one or more sets of training data 122 and/or machine learning models 124 may be stored in storage 114.

Memory 116 may include a random access memory (RAM) module, a flash memory unit, or any other type of memory unit or combination thereof. Processing unit(s) 102, I/O device interface 104, and network interface 106 are configured to read data from and write data to memory 116. Memory 116 includes various software programs that can be executed by processor(s) 102 and application data associated with said software programs, including active learning framework 120.

Active learning framework 120 includes functionality to manage and/or improve the creation of machine learning models 124 based on training data 122 for machine learning models 124. Machine learning models 124 include, but are not limited to, artificial neural networks (ANNs), decision trees, support vector machines, regression models, naïve Bayes classifiers, deep learning models, clustering techniques, Bayesian networks, hierarchical models, and/or ensemble models.

Training data 122 include features inputted into machine learning models 124, as well as labels representing outcomes, categories, and/or classes to be predicted or inferred based on the features. For example, features in training data 122 may include representations of words and/or text in Information Technology (IT) incident tickets, and labels associated with the features may include incident categories that are used to route the tickets to agents with experience in handling and/or resolving the types of incidents, requests, and/or issues described in the tickets.

In one or more embodiments, active learning framework 120 trains one or more machine learning models 124 so that each machine learning model predicts labels in a set of training data 122, given features in the same set of training data 122. Continuing with the above example, active learning framework 102 may train a machine learning model to predict an incident category for an incident ticket, given the content of the incident ticket and/or embedded representations of words in the incident ticket.

As described in further detail below, active learning framework 120 includes functionality to train machine learning models 124 using original labels in training data 122. Active learning framework 120 also updates the labels based on clusters of training data 122 with common or similar feature values and/or internal representations of the features from machine learning models 124. Active learning framework 120 also, or instead, updates additional labels in the clustered training data 122 based on user annotations of the labels. As a result, active learning framework 102 may reduce noise and/or inconsistencies in the labels and/or improve the performance of machine learning models 124 trained using the labels.

### Active Learning to Reduce Noise in Labels

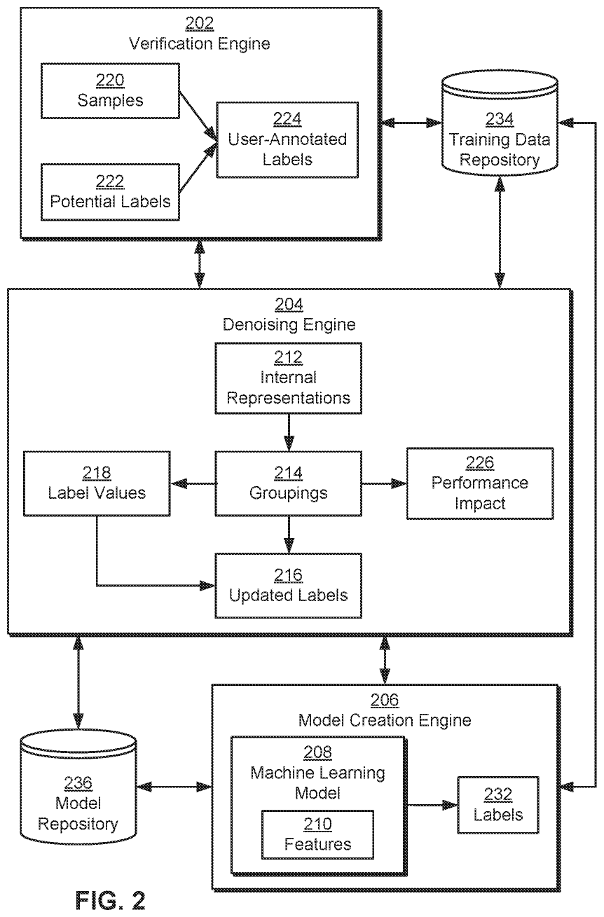

FIG. 2 is a more detailed illustration of active learning framework 120 of FIG. 1, according to various embodiments of the present invention. As shown, active learning framework 120 includes a user interface 202, a denoising engine 204, and a model creation engine 206. Each of these components is described in further detail below.

Model creation engine 206 trains a machine learning model 208 using one or more sets of training data from a training data repository 234. More specifically, model creation engine 206 trains machine learning model 208 to predict labels 232 in the training data based on features 210 in the training data. For example, model creation engine 206 may update parameters of machine learning model 208 using an optimization technique and/or one or more hyperparameters so that predictions outputted by machine learning model 208 from features 210 reflect the corresponding labels 232. After machine learning model 208 is trained, model creation engine 206 may store parameters of machine learning model 208 and/or another representation of machine learning model 208 in a model repository 236 for subsequent retrieval and use.

Those skilled in the art will appreciate that training data for machine learning model 208 may include labels 232 that are inaccurate, noisy, and/or missing. For example, the training data may include features 210 representing incident tickets and labels 232 representing incident categories that are used to route the incident tickets to agents and/or teams that are able to resolve issues described in the incident tickets. Within the training data, a given incident ticket may be manually labeled with a corresponding incident category by a human agent. As a result, labels 232 may include mistakes by human agents in categorizing the incident tickets, inconsistencies in categorizing similar incident tickets by different human agents, and/or changes to the categories and/or routing of the incident tickets over time.

In one or more embodiments, denoising engine 204 includes functionality to improve the quality of labels 232 in training data for machine learning model 208. As shown, denoising engine 204 generates groupings 214 of training data for machine learning model 208 based on internal representations 212 of the training data from machine learning model 208.

Internal representations 212 include values derived from features 210 after features 210 are inputted into machine learning model 208. For example, internal representations 212 may include embeddings and/or other encoded or vector representations of text, images, audio, categorical data, and/or other types of data in features 210. In another example, internal representations 212 may include outputs of one or more hidden layers in a neural network and/or other intermediate values associated with processing of features 210 by other types of machine learning models.

More specifically, denoising engine 214 generates groupings 214 of features 210 and labels 232 in the training data by clustering the training data by internal representations 212. For example, denoising engine 214 may use k-means clustering, spectral clustering, balanced iterative reducing and clustering using hierarchies (BIRCH), and/or another type of clustering technique to generate groupings 214 of the training data by values of internal representations 212. Because internal representations 212 are used by machine learning model 208 to discriminate between different labels 232 based on the corresponding features 210, clustering of the training data by internal representations 212 allows denoising engine 214 to identify groupings 214 of features 210 that produce different labels 232, even when significant noise and/or inconsistency is present in the original labels 232.

Prior to generating groupings 214, denoising engine 204 optionally reduces a dimensionality of internal representations 212 by which the training data is clustered. For example, denoising engine 204 may use principal components analysis (PCA), linear discriminant analysis (LDA), matrix factorization, autoencoding, and/or another dimensionality reduction technique to reduce the complexity of internal representations 212 prior to clustering the training data by internal representations 212.

After groupings 214 are generated, denoising engine 204 generates updated labels 216 for training data in each grouping based on the occurrences of label values 218 of original labels 232 in the grouping. For example, denoising engine 204 may select an updated label as the most frequently occurring label value in a given cluster of training data. Denoising engine 204 then replaces label values 218 in the cluster with the updated label.

After updated labels 216 are generated for a given set of groupings 214 of the training data, model creation engine 206 retrains machine learning model 208 using features 210 and the corresponding updated labels 216. In turn, denoising engine 204 uses internal representations 212 of the retrained machine learning model 208 to generate new groupings 214 of the training data and select updated labels 216 for the new groupings 214. Model creation engine 206 and denoising engine 204 may continue iteratively training machine learning model 208 using features 210 and updated labels 216 from a previous iteration, generating new groupings 214 of training data by internal representations 212 of the training data from the retrained machine learning model 208, and generating new sets of updated labels 216 to improve the consistency of groupings 214 and/or labels 232 in groupings 214. After the accuracy of machine learning model 208 and/or the consistency of groupings 214 and/or labels 232 converges, model creation engine 206 and denoising engine 204 may discontinue updating machine learning model 208, groupings 214, and labels 232.

During iterative updating of machine learning model 208, groupings 214, and label 232, denoising engine 204 may vary the techniques used to generate groupings 214. For example, denoising engine 204 may calculate, for each grouping of training data, the proportion of original and/or current labels 232 that differ from the updated label selected for the grouping. Denoising engine 204 may then generate another set of groupings 214 of the training data by clustering the training data by the proportions of mismatches between original labels 232 and updated labels 216 in the original groupings 214.

In another example, denoising engine 204 may produce multiple sets of clusters of training data by varying the numbers and/or combinations of hidden layers in a neural network used to generate each set of clusters. Denoising engine 204 may then select a set of clusters of training data as groupings 214 for which updated labels 216 are generated based on evaluation measures such as cluster purity, cluster tendency, and/or user input (e.g., user feedback identifying a combination of internal representations 212 that result in the best groupings 214 of training data).

Verification engine 202 obtains and/or generates user-annotated labels 224 that are used to verify updated labels 216 and/or original labels 232 in the training data. In some embodiments, verification engine 202 outputs samples 220 of the training data 220 and potential labels 222 for samples 220 in a graphical user interface (GUI), web-based user interface, command line interface (CLI), voice user interface, and/or another type of user interface. For example, verification engine 202 may display text from incident tickets as samples 220 and incident categories to which the incident tickets may belong as potential labels 222 for samples 220.

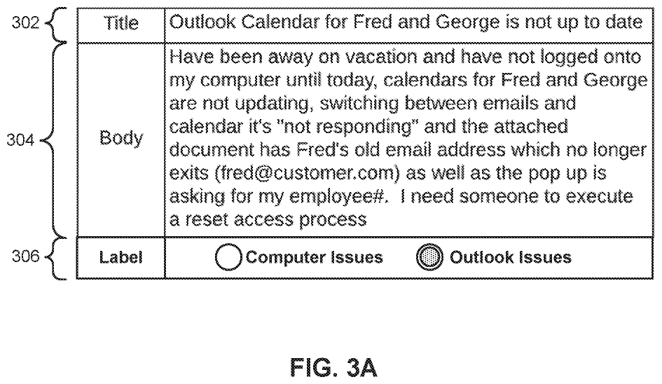

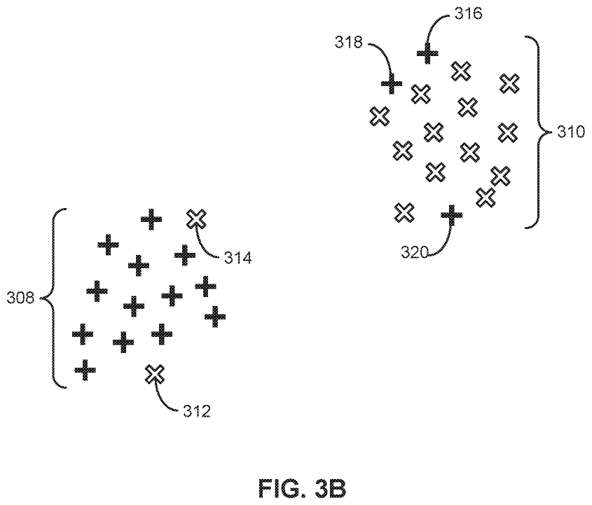

Verification engine 202 also allows users involved in the development and/or use of machine learning model 208 to specify user-annotated labels 224 for samples 220 through the user interface. Continuing with the above example, verification engine 202 may generate radio buttons, drop-down menus, and/or other user-interface elements that allow a user to select a potential label as a user-annotated label for one or more samples 220 from a grouping of training data. Verification engine 202 may also, or instead, allow the user to confirm an original label and/or updated label for the same samples 220, select different labels for different samples 220 in the same grouping, and/or provide other input related to the accuracy or values of labels for samples 220. User interfaces for obtaining user-annotated labels for training data are described in further detail below with respect to FIG. 3.

In one or more embodiments, verification engine 202 identifies and/or selects groupings 214 of training data for which user-annotated labels 224 are to be obtained based on a performance impact 226 of each grouping of training data on machine learning model 208. In these embodiments, performance impact 226 includes, but is not limited to, a measure of the contribution of each grouping of training data on the accuracy and/or output of machine learning model 208.

In some embodiments, denoising engine 204 and/or another component of the system assess performance impact 226 based on attributes associated with groupings 214. For example, the component may calculate performance impact 226 based on the size of each grouping of training data, with a larger grouping of training data (i.e., a grouping with more rows of training data) representing a larger impact on the performance of machine learning model 208 than a smaller grouping of training data. In another example, the component may calculate performance impact 226 based on an entropy associated with original labels 232 in the grouping, with a higher entropy (i.e., greater variation in labels 232) representing a larger impact on the performance of machine learning model 208 than a lower entropy. In a third example, the component may calculate performance impact 226 based on the proportion of mismatches between the original labels 232 in the grouping and an updated label for the grouping, with a higher proportion of mismatches indicating a larger impact on the performance of machine learning model 208 than a lower proportion of mismatches. In a fourth example, the component may calculate performance impact 226 based on the uncertainty of predictions by machine learning model 208 generated from a grouping of training data, with a higher prediction uncertainty (i.e., less confident predictions by machine learning model 208) indicating a larger impact on the performance of machine learning model 208 than a lower prediction uncertainty.

In some embodiments, the component also includes functionality to assess performance impact 226 based on combinations of attributes associated with groupings 214. For example, the component may identify mismatches between the original labels 232 in a grouping and the updated label for the grouping and sum the scores outputted by machine learning model 208 in predicting the mismatched original labels 232 in the grouping. As a result, a higher sum of outputted scores associated with the mismatches represents a greater impact on the performance of machine learning model 208 than a lower sum of outputted scores associated with the mismatches. In another example, the component may calculate a measure of performance impact 226 for each grouping of training data as a weighted combination of the size of the grouping, the entropy associated with the original labels 232 in the grouping, the proportion of mismatches between the original labels 232 and the updated label for the grouping, the uncertainty of predictions associated with the grouping, and/or other attributes associated with the grouping.

Verification engine 202 utilizes measures of performance impact 226 for groupings 214 to target the generation of user-annotated labels 224 for groupings 214 with the highest performance impact 226. For example, verification engine 202 may output a ranking of groupings 214 by descending performance impact 226. Within the ranking, verification engine 202 may display an estimate of the performance gain associated with obtaining a user-annotated label for each grouping (e.g., “if you provide feedback on this grouping of samples, you can improve accuracy by 5%”) to incentivize user interaction with samples in the grouping. In another example, verification engine 202 may select a number of groupings 214 with the highest performance impact 226, output samples 220 and potential labels 222 associated with the selected groupings 214 within the user interface, and prompt users interacting with the user interface to provide user-annotated labels 224 based on the outputted samples 220 and potential labels 222.

After updated labels 216 and/or user-annotated labels 224 are used to improve the quality of labels in the training data, model creation engine 206 trains a new version of machine learning model 208 using features 210 in the training data and the improved labels 232. Model creation apparatus 206 may then store the new version in model repository 236 and/or deploy the new version in a production and/or real-world setting. Because the new version is trained using more consistent and/or accurate labels 232, the new version may have better performance and/or accuracy than previous versions of machine learning model 208 and/or machine learning models that are trained using training data with noisy and/or inconsistent labels.

FIG. 3A is an example screenshot of a user interface provided by verification engine 202 of FIG. 2, according to various embodiments. As shown, the user interface of FIG. 3 includes three portions 302-306.

Portions 302-304 are used to display a sample from a grouping of training data for a machine learning model, and portion 306 is used to display potential labels for the sample and obtain a user-annotated label for the sample. More specifically, portion 302 includes a title for an incident ticket, and portion 304 includes a body of the incident ticket. Portion 306 includes two potential incident categories for the incident ticket, as well as two radio buttons that allow a user to select one of the incident categories as a user-annotated label for the incident ticket.

The sample shown in portions 302-304 is selected to be representative of the corresponding grouping of training data. For example, the incident ticket may be associated with an original label that differs from the most common label in the grouping and/or an updated label for the grouping. In another example, a topic modeling technique may be used to identify one or more topics in the incident ticket that are shared with other incident tickets in the same grouping of training data and/or distinct from topics in the other incident tickets. In a third example, the machine learning model may predict the original label of the incident ticket with a low confidence and/or high uncertainty.

The user interface of FIG. 3A optionally includes additional features that assist the user with generating the user-annotated label for the sample and/or verifying labels for groupings of training data. For example, the user interface may highlight words and/or phrases in portion 302 or 304 that contribute significantly to the machine learning model's prediction (e.g., “Outlook Calendar,” “logged onto,” “computer,” “emails,” “attached document,” “email address,” etc.). Such words and/or phrases may be identified using a phrase-based model that mimics the prediction of the machine learning model, a split in a decision tree, and/or other sources of information regarding the behavior of the machine learning model.

In another example, the user interface may include additional samples in the same grouping of training data, along with user-interface elements that allow the user to select a user-annotated label for the entire grouping from potential labels that include the original labels for the samples, one or more updated labels for the grouping, and/or one or more high-frequency labels in the grouping. The user interface may also, or instead, include user-interface elements that allow the user to select a different user-annotated label for each sample and/or verify the accuracy of the most recent label for each sample or all samples. User-annotated labels and/or other input provided by the user through the user interface may then be used to update the label for the entire grouping, assign labels to individual samples in the grouping, reassign samples to other groupings of training data, and/or generate new groupings of the training data that better reflect the user-annotated labels.

FIG. 3B is an example illustration of groupings 308-310 of training data generated by denoising engine 204 of FIG. 2, according to various embodiments. As shown, groupings 308-310 include clusters of training data that are generated based on internal representations of the training data from a machine learning model. For example, denoising engine 204 may generate groupings 308-310 by applying PCA, LDA, and/or another dimensionality reduction technique to outputs generated by one or more hidden layers of a neural network from different points in the training data to generate a two-dimensional representation of the outputs. Denoising engine 204 may then use spectral clustering, BIRCH, and/or another clustering technique to generate groupings 308-310 of the training data from the two-dimensional representation.

As discussed above, denoising engine 204 also replaces original labels of points in each grouping with updated labels that are selected based on occurrences of values of the original labels in the grouping. As shown, most points in grouping 308 are associated with one label, while two points 312-314 in grouping 308 are associated with another label. Conversely, most points in grouping 310 are associated with the same label as points 312-314 in grouping 308, while three points 316-320 in grouping 310 are associated with the same label as the majority of points in grouping 308.

As a result, denoising engine 204 may identify an updated label for points 312-314 as the label associated with remaining points in the same cluster 308 and replace the original labels associated with points 312-314 with the updated label. Similarly, denoising engine 204 may identify a different updated label for points 316-320 as the label associated with remaining points in the same cluster 310 and replace the original labels associated with points 316-320 with the updated label. After denoising engine 204 applies updated labels to points groupings 308-310, all points in each grouping may have the same label.

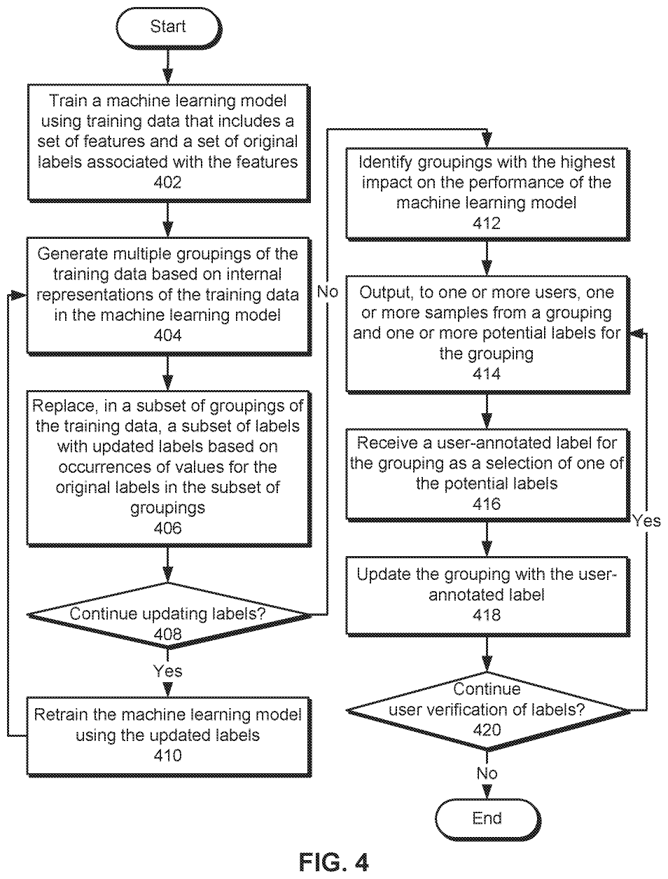

FIG. 4 is a flow diagram of method steps for processing training data for a machine learning model, according to various embodiments. Although the method steps are described in conjunction with the systems of FIGS. 1-2, persons skilled in the art will understand that any system configured to perform the method steps, in any order, is within the scope of the present invention.

As shown, model creation engine 206 trains 402 a machine learning model using training data that includes a set of features and a set of original labels associated with the features. For example, model creation engine 206 may train a neural network, tree-based model, and/or another type of machine learning model to predict the original labels in the training data, given the corresponding features.

Next, denoising engine 204 generates 404 multiple groupings of the training data based on internal representations of the training data in the machine learning model. The internal representations may include, but are not limited to, embeddings and/or encodings of the features, hidden layer outputs of a neural network, and/or other types of intermediate values associated with processing of features by machine learning models. To produce the groupings, denoising engine 204 may reduce the dimensionality of the internal representations and/or cluster the training data by the internal representations, with or without the reduced dimensionality.

Denoising engine 204 then replaces 406, in a subset of groupings of the training data, a subset of labels with updated labels based on occurrences of values for the original labels in the subset of groupings. For example, denoising engine 204 may identify the most common label in each grouping and update all samples in the grouping to include the most common label.

Model creation engine 206 and denoising engine 204 may continue 408 updating labels based on groupings of the training data. While updating of the labels continues, model creation engine 206 retrains 410 the machine learning model using the updated labels from a previous iteration. Denoising engine 204 then generates 404 groupings of the training data based on internal representations of the training data in the machine learning model and replaces 406 a subset of labels in the groupings with updated labels based on the occurrences of different labels in the groupings. Model creation engine 206 and denoising engine 204 may repeat operations 404-410 until changes to the groupings of training data and/or the corresponding labels fall below a threshold.

Denoising engine 204 identifies 412 groupings with the highest impact on the performance of the machine learning model. For example, denoising engine 204 may determine an impact of each grouping of the training data on the performance of the machine learning model as a numeric value that is calculated based on the amount of the training data in the grouping, an entropy associated with the original labels in the grouping, a proportion of mismatches between the original labels and an updated label for the grouping, an uncertainty of predictions generated by the machine learning model for the grouping, and/or other attributes. Denoising engine 204 may rank the groupings by descending impact and use the ranking to select a subset of groupings with the highest impact on the performance of the machine learning model.

Verification engine 202 then obtains user-annotated labels for some or all of the identified groupings. First, verification engine 202 outputs 414, to one or more users, one or more samples from a grouping and one or more potential labels for the grouping. For example, verification engine 202 may display, in a user interface, a representation of a sample and potential labels that include the original label for the sample, the updated label for the grouping, and/or a high-frequency label in the grouping. Verification engine 202 may highlight a portion of a sample that contributes to a prediction by the machine learning model. Verification engine 202 may also, or instead, output multiple samples with different original labels from the grouping in the user interface.

Next, verification engine 202 receives 416 a user-annotated label for the grouping as a selection of one of the potential labels. Continuing with the above example, a user may interact with user-interface elements in the user interface to specify one of the potential labels as the real label for the sample.

Verification engine 202 then updates 418 the grouping with the user-annotated label. For example, verification engine 202 may replace all other labels in the grouping with the user-annotated label.

Verification engine 202 may continue 420 user verification of labels by repeating operations 414-418 with other samples and/or groupings. For example, verification engine 202 may continue outputting samples from different groupings and updating the groupings with user-annotated labels until the user(s) performing the annotation discontinue the annotation process, labels in a threshold number of samples and/or groupings have been verified by the users, and/or the performance of the machine learning model has increased by a threshold amount.

In sum, the disclosed techniques update labels in training data for machine learning models. The training data is clustered and/or grouped based on internal representations of the training data from the machine learning models, and labels in each cluster or group of training data are assigned to the same value to reduce noise and/or inconsistencies in the labels. Labels for subsets of the training data that have the highest impact on model performance are further updated based on user input. The labels may continue to be updated by iteratively retraining the machine learning models using the features and updated labels and subsequently updating the labels in clusters of training data associated with internal representations of the features from the retrained machine learning models.

By updating labels in training data to reflect internal representations of features from machine learning models trained using the training data, the disclosed techniques reduce noise, inconsistency, and/or inaccuracy in labels used to train machine learning models. In turn, improvements in the quality of the labels provide additional improvements in the training and performance of the machine learning models. The disclosed techniques provide additional efficiency gains and/or performance improvements with minimal computational and/or manual overhead by performing user verification and/or annotation of labels for subsets of the training data that are identified as having the greatest impact on model performance. Consequently, the disclosed techniques provide technological improvements in the training, execution, and performance of machine learning models and/or the execution and performance of applications, tools, and/or computer systems for performing cleaning and/or denoising of data.

1. In some embodiments, a method for processing training data for a machine learning model comprises training the machine learning model using training data comprising a set of features and a set of original labels associated with the set of features; generating multiple groupings of the training data based on internal representations of the training data in the machine learning model; and replacing, in a first subset of groupings of the training data, a first subset of the original labels with updated labels based at least on occurrences of values for the original labels in the first subset of groupings.

2. The method of clause 1, further comprising retraining the machine learning model using the updated labels; and updating the multiple groupings of the training data based on updated internal representations of the training data in the retrained machine learning model.

3. The method of clauses 1-2, further comprising identifying a second subset of groupings of the training data with a highest impact on a performance of the machine learning model; and updating the second subset of groupings with user-annotated labels.

4. The method of clauses 1-3, wherein updating the second subset of groupings with user-annotated labels comprises for each grouping of the training data in the second subset of groupings, outputting, to one or more users, one or more samples from the grouping and one or more potential labels for the grouping; and receiving a user-annotated label for the grouping as a selection of a label in the one or more potential labels.

5. The method of clauses 1-4, wherein outputting the one or more samples from the grouping comprises at least one of highlighting a portion of a sample that contributes to a prediction by the machine learning model; and outputting multiple samples with different original labels from the grouping.

6. The method of clauses 1-5, wherein the one or more potential labels comprise at least one of an original label in the grouping, an updated label for the grouping, and a high-frequency label in the grouping.

7. The method of clauses 1-6, wherein identifying the second subset of groupings of the training data with the highest impact on the performance of the machine learning model comprises determining an impact of a grouping of the training data on the performance of the machine learning model based on at least one of an amount of the training data in the grouping, an entropy associated with the original labels in the grouping, a proportion of mismatches between the original labels in the grouping and an updated label for the grouping, and an uncertainty of predictions generated by the machine learning model for the grouping.

8. The method of clauses 1-7, wherein generating the multiple groupings of the training data comprises clustering the training data by the internal representations.

9. The method of clauses 1-8, wherein clustering the training data by the internal representations comprises at least one of reducing a dimensionality of the internal representations prior to clustering the training data by the internal representations; and clustering the training data based on proportions of mismatches between the original labels in previous groupings of the training data and updated labels for the previous groupings.

10. The method of clauses 1-9, wherein the internal representations comprise at least one of an encoding of a feature and an output of a hidden layer of the machine learning model.

11. The method of clauses 1-10, wherein the machine learning model comprises a neural network.

12. The method of clauses 1-11, wherein the features comprise representations of words in incident tickets and the original labels comprise incident categories used in routing and resolution of the incident tickets.

13. In some embodiments, a non-transitory computer readable medium stores instructions that, when executed by a processor, cause the processor to perform the steps of training a machine learning model using training data comprising a set of features and a set of original labels associated with the set of features; generating multiple groupings of the training data as clusters of internal representations of the training data in the machine learning model; identifying a first subset of groupings of the training data with a highest impact on a performance of the machine learning model; and replacing a first subset of the original labels in the first subset of groupings with user-annotated labels from one or more users.

14. The non-transitory computer readable medium of clause 13, wherein the steps further comprise replacing, in a second subset of groupings of the training data, a second subset of the original labels with updated labels based at least on occurrences of values for the original labels in the first subset of groupings; retraining the machine learning model using the updated labels; and updating the multiple groupings of the training data based on updated internal representations of the training data in the retrained machine learning model.

15. The non-transitory computer readable medium of clauses 13-14, wherein replacing the first subset of the original labels in the first subset of groupings with the user-annotated labels from the one or more users comprises for each grouping of the training data in the first subset of groupings, outputting, to the one or more users, one or more samples from the grouping and one or more potential labels for the grouping; and receiving, from the one or more users, a user-annotated label for the grouping as a selection of a label in the one or more potential labels.

16. The non-transitory computer readable medium of clauses 13-15, wherein outputting the one or more samples from the grouping comprises at least one of highlighting a portion of a sample that contributes to a prediction by the machine learning model; and outputting multiple samples with different original labels from the grouping.

17. The non-transitory computer readable medium of clauses 13-16, wherein identifying the first subset of groupings of the training data with the highest impact on the performance of the machine learning model comprises determining an impact of a grouping of the training data on the performance of the machine learning model based on at least one of an amount of the training data in the grouping, an entropy associated with the original labels in the grouping, a proportion of mismatches between the original labels in the grouping and an updated label for the grouping, and an uncertainty of predictions generated by the machine learning model for the grouping.

18. The non-transitory computer readable medium of clauses 13-17, wherein generating the multiple groupings of the training data comprises reducing a dimensionality of the internal representations; and clustering the training data by the internal representations with the reduced dimensionality.

19. The non-transitory computer readable medium of clauses 13-18, wherein the internal representations comprise at least one of an encoding of a feature and an output of a hidden layer of the machine learning model.

20. In some embodiments, a system comprises a memory that stores instructions; and a processor that is coupled to the memory and, when executing the instructions, is configured to train the machine learning model using training data comprising a set of features and a set of original labels associated with the set of features, generate multiple groupings of the training data based on internal representations of the training data in the machine learning model, and replace, in a first subset of groupings of the training data, a first subset of the original labels with updated labels based at least on most frequently occurring values for the original labels in the first subset of groupings.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method for processing training data for a machine learning model, comprising:
training the machine learning model using training data comprising a set of features and a set of original labels associated with the set of features;
generating multiple groupings of the training data based on internal representations of the training data in the machine learning model; and
replacing, in a first subset of groupings of the training data, a first subset of the original labels with updated labels based at least on occurrences of values for the original labels in the first subset of groupings.

2. The method of claim 1, further comprising:
retraining the machine learning model using the updated labels; and
updating the multiple groupings of the training data based on updated internal representations of the training data in the retrained machine learning model.

3. The method of claim 1, further comprising:
identifying a second subset of groupings of the training data with a highest impact on a performance of the machine learning model; and
updating the second subset of groupings with user-annotated labels.

4. The method of claim 3, wherein updating the second subset of groupings with user-annotated labels comprises:
for each grouping of the training data in the second subset of groupings, outputting, to one or more users, one or more samples from the grouping and one or more potential labels for the grouping; and
receiving a user-annotated label for the grouping as a selection of a label in the one or more potential labels.

5. The method of claim 4, wherein outputting the one or more samples from the grouping comprises at least one of:
highlighting a portion of a sample that contributes to a prediction by the machine learning model; and
outputting multiple samples with different original labels from the grouping.

6. The method of claim 4, wherein the one or more potential labels comprise at least one of an original label in the grouping, an updated label for the grouping, and a high-frequency label in the grouping.

7. The method of claim 3, wherein identifying the second subset of groupings of the training data with the highest impact on the performance of the machine learning model comprises determining an impact of a grouping of the training data on the performance of the machine learning model based on at least one of an amount of the training data in the grouping, an entropy associated with the original labels in the grouping, a proportion of mismatches between the original labels in the grouping and an updated label for the grouping, and an uncertainty of predictions generated by the machine learning model for the grouping.

8. The method of claim 1, wherein generating the multiple groupings of the training data comprises clustering the training data by the internal representations.

9. The method of claim 8, wherein clustering the training data by the internal representations comprises at least one of:
reducing a dimensionality of the internal representations prior to clustering the training data by the internal representations; and
clustering the training data based on proportions of mismatches between the original labels in previous groupings of the training data and updated labels for the previous groupings.

10. The method of claim 1, wherein the internal representations comprise at least one of an encoding of a feature and an output of a hidden layer of the machine learning model.

11. The method of claim 1, wherein the machine learning model comprises a neural network.

12. The method of claim 1, wherein the features comprise representations of words in incident tickets and the original labels comprise incident categories used in routing and resolution of the incident tickets.

13. A non-transitory computer readable medium storing instructions that, when executed by a processor, cause the processor to perform the steps of:
training a machine learning model using training data comprising a set of features and a set of original labels associated with the set of features;
generating multiple groupings of the training data as clusters of internal representations of the training data in the machine learning model;
identifying a first subset of groupings of the training data with a highest impact on a performance of the machine learning model; and
replacing a first subset of the original labels in the first subset of groupings with user-annotated labels from one or more users.

14. The non-transitory computer readable medium of claim 13, wherein the steps further comprise:
replacing, in a second subset of groupings of the training data, a second subset of the original labels with updated labels based at least on occurrences of values for the original labels in the first subset of groupings;
retraining the machine learning model using the updated labels; and
updating the multiple groupings of the training data based on updated internal representations of the training data in the retrained machine learning model.

15. The non-transitory computer readable medium of claim 13, wherein replacing the first subset of the original labels in the first subset of groupings with the user-annotated labels from the one or more users comprises:
for each grouping of the training data in the first subset of groupings, outputting, to the one or more users, one or more samples from the grouping and one or more potential labels for the grouping; and
receiving, from the one or more users, a user-annotated label for the grouping as a selection of a label in the one or more potential labels.

16. The non-transitory computer readable medium of claim 15, wherein outputting the one or more samples from the grouping comprises at least one of:
highlighting a portion of a sample that contributes to a prediction by the machine learning model; and
outputting multiple samples with different original labels from the grouping.

17. The non-transitory computer readable medium of claim 13, wherein identifying the first subset of groupings of the training data with the highest impact on the performance of the machine learning model comprises determining an impact of a grouping of the training data on the performance of the machine learning model based on at least one of an amount of the training data in the grouping, an entropy associated with the original labels in the grouping, a proportion of mismatches between the original labels in the grouping and an updated label for the grouping, and an uncertainty of predictions generated by the machine learning model for the grouping.

18. The non-transitory computer readable medium of claim 13, wherein generating the multiple groupings of the training data comprises:
reducing a dimensionality of the internal representations; and
clustering the training data by the internal representations with the reduced dimensionality.

19. The non-transitory computer readable medium of claim 13, wherein the internal representations comprise at least one of an encoding of a feature and an output of a hidden layer of the machine learning model.

20. A system, comprising:
a memory that stores instructions; and
a processor that is coupled to the memory and, when executing the instructions, is configured to:
train the machine learning model using training data comprising a set of features and a set of original labels associated with the set of features,
generate multiple groupings of the training data based on internal representations of the training data in the machine learning model, and
replace, in a first subset of groupings of the training data, a first subset of the original labels with updated labels based at least on most frequently occurring values for the original labels in the first subset of groupings.
